(19) United States
(12) Patent Application Publication
(10) Pub. No.: US 2002/0184615 A1
(43) Pub. Date: Dec. 5, 2002

(54) System and method for selectively and automatically modifying the source code of a computer program

(76) Inventors: William Earl Sumner, Plano, TX (US); Moon Ki Cho, Hoffman Estates, IL (US)

Correspondence Address: HEWLETT-PACKARD COMPANY, Intellectual Property Administration, P.O. Box 272400, Fort Collins, CO, 80527-2400, US

(21) Appl. No.: 09/841,981

(22) Filed: Apr. 25, 2001

(51) Int. Cl. G06F 9/44

(52) U.S. Cl. 717/130; 717/131; 717/143

(57) ABSTRACT

A system and method for automatically and selectively modifying the source code of a computer program. A parser is provided for scanning the source code portion to recognize select syntax structures of the source code. A code modification portion is included in the parser which inserts instrumentation code at select locations of the source code based on the modification code. The instrumented source code can be compiled and executed using test loads to exercise different portions of the source code and obtain statistics such as frequency of global variable accesses, function calls, frequency of use of multiple code paths, etc.

### BACKGROUND OF THE INVENTION

1. Technical Field of the Invention

The present invention generally relates to software tools. More particularly, and not by way of any limitation, the present invention is directed to a system and method for selectively and automatically modifying the source code of a computer program.

2. Description of Related Art

When testing or analyzing the performance of any large, complex software program such as an operating system, there is a need to measure various aspects of the software's operation under a realistic load. For instance, information relating to the frequency of use of different code paths, frequency of function calls, accesses to one or more global variables (GVs) from different modules, et cetera, is useful in designing optimized code interfaces in the software program.

Depending on the type of the software program, several solutions exist that address this need. For example, with respect to operating system kernels, extensible modules are available to extend functionality and specify kernel policies wherein specialized versions of certain kernel functions are installed at runtime for providing dynamic optimization. Self-measuring and self-adapting extensible kernels are also known.

Also, software debuggers are sometimes used for monitoring accesses to global variables in a computer program. Further, software simulators and specialized scripts (e.g., written in PERL) can be used in some applications for measuring the GV access statistics. Commercial products such as C-COVER are operable to insert bit flags in the source code of a computer program in order to measure which portions of the code have been exercised under a test load.

Although these solutions have been generally useful, they are beset with several deficiencies and shortcomings. For instance, whereas the use of simulators and specialized scripts can be advantageous for instrumenting a computer program in order to obtain performance statistics, resultant disk space usage is typically quite excessive. Accordingly, the amount of data that can be collected is rather too limited to be of significant value. Furthermore, instrumented simulators are very slow compared to the normal execution speed of the software, and this limits the size and complexity of the workloads that can be used to exercise the software. On the other hand, debugger tools are generally very quick, with near full execution speeds. However, they are limited to monitoring accesses to only a few GVs at a time. Similarly, the specialized scripts for instrumenting a computer program become too bulky when several GVs or function calls are to be monitored.

Additionally, with respect to operating system software, most of the extensible kernels for providing runtime instrumentation are operable with customized kernels only. As a consequence, they are not well suited for use with real-world programs or workloads. Finally, bit flag insertion is too rudimentary a technique to provide useful instrumentation in complex computer programs.

### SUMMARY OF THE INVENTION

Accordingly, the present invention advantageously provides a system and method for automatically and selectively instrumenting the source code of a computer program without these and other shortcomings and deficiencies of the current solutions. A parser is provided for scanning the source code portion to recognize select syntax structures of the source code. A code modification portion is included in the parser which inserts instrumentation code at select locations of the source code based on the modification code. The instrumented source code can be compiled and executed using test loads to exercise different portions of the source code, and thereby obtain statistical data such as the frequency of GV accesses, function calls, frequency of use of multiple code paths, etc.

In an exemplary embodiment of the present invention, the method of modifying a source code portion associated with a computer program comprises the step of scanning the entire source code portion using a parser having one or more predetermined code modification portions that are operable to insert instrumentation code at selected locations in the source code. Preferably, any computer program can be modified accordingly, which computer program may be selected from the group consisting of, for instance, an operating system kernel (e.g., HP-UX kernel), an application program and a software utility program. The computer program's source code may be written in any language, e.g., in the C language. Accordingly, a C language parser such as the recursive-descent parser is preferably used, wherein the C parser is coded using the Backus-Naur Form (BNF) description of ANSI C. The predetermined code modification portions of the parser are operable to recognize select syntax structures of the source code portion and insert an instrumentation code portion at a location associated with the select syntax structure based on the content of the code modification portion of the parser. For example, counters may be instrumented at the global variable calls in the source code portion so that when the global variables are accessed during runtime, associated counters are operable to track such accesses. Similarly, a code modification portion of the parser is operable to insert instrumentation code at select locations in the source code portion in order to keep track of accesses to a particular GV from a select module of the source code.

In another exemplary embodiment, the method of modifying the source code portion associated with a computer program may also include the step of pre-processing the source code so as to remove macros, comments and other extraneous portions from the source code.

In a further aspect, the present invention is directed to a computer-readable medium operable with a processing environment, the computer-readable medium carrying a sequence of instructions which, when executed in the processing environment, causes the processing environment to perform the steps of the source code modification method summarized hereinabove. In an exemplary embodiment, the processing environment may be comprised of a hardware architecture simulator for a target multiprocessing system.

### BRIEF DESCRIPTION OF THE DRAWINGS

A more complete understanding of the present invention may be had by reference to the following Detailed Description when taken in conjunction with the accompanying drawings wherein:

FIG. 1 is a flow chart of the steps involved in an exemplary source code modification method provided in accordance with the teachings of the present invention;

FIG. 2 depicts a high level functional block diagram of an exemplary source code modification system provided in accordance with the teachings of the present invention;

FIG. 3A depicts an exemplary embodiment of a source code prior to modification;

FIG. 3B depicts an exemplary embodiment of the source code after modification; and

FIG. 4 depicts a block diagram of an exemplary multiprocessing system whose operating system code may be advantageously modified using the teachings of the present invention.

### DETAILED DESCRIPTION OF THE DRAWINGS

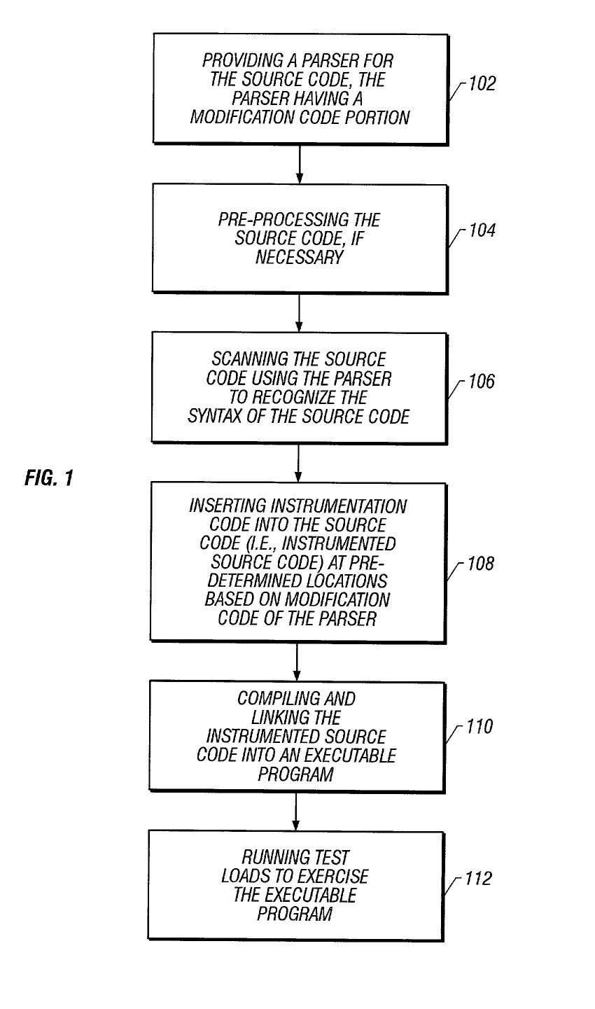

In the drawings, like or similar elements are designated with identical reference numerals throughout the several views thereof, and the various elements depicted are not necessarily drawn to scale. Referring now to FIG. 1, depicted therein is a flow chart of the steps in an exemplary source code modification method provided in accordance with the teachings of the present invention for modifying the source code of a computer program. Preferably, any computer program such as, for example, an operating system kernel, an application program, any software utility, et cetera, can be modified by using the teachings of the present invention. Furthermore, the source code of the computer program may be written in any known or heretofore unknown computer language such as, for instance, C or C++, and the like. Accordingly, depending on the source code of the computer program, a suitable parser is provided (step 102) wherein one or more predetermined code modification portions are included in accordance with the teachings of the present invention set forth in greater detail hereinbelow.

In a presently preferred exemplary embodiment of the present invention, a C language parser such as the recursive-descent parser is utilized wherein the C parser is coded using the Backus-Naur Form (BNF) description of ANSI C. The recursive-descent parser is operable to provide functions to handle each syntactical structure or element of the source code language, e.g., ANSI C, which consequently permits easy identification of a suitable location in the parser's source code that corresponds to the syntactical structure of the computer program being parsed. These functions are substantially simple in general and consist of the following operations: consuming tokens, determining which of several possible alternative elements follows in a statement, calling other functions to handle that alternative, and returning to their caller when the handling of their own syntactical element is complete.

Because the teachings of the present invention are particularly exemplified in the context of using the recursive-descent C language parser, the general operation thereof is immediately set forth below.

In the presently preferred exemplary implementation, the C language parser makes heavy use of the language's ability to support recursive function calls, that is, a function that calls itself either directly or by calling other functions that eventually call the original function again. In the parser, this typically happens when an instance of a particular syntactical element contains other instances of the same type of syntactical element. For example, a compound statement (i.e., a statement inside the curly braces in C—e.g, {statement}) may contain other compound statements. As can be readily appreciated by those skilled in the art, an advantageous feature of this technique is that the programming for each function only needs to handle one instance of its syntactic element. For any other instances of the syntactic element contained in this instance, the function will be called again, recursively, as necessary.

In one embodiment, the source program to be parsed is provided as a memory mapped input file. Thus, each execution of the parser reads one C language source file specified on the command line of the code. The source file is accessed by memory mapping it into the address space of the parser as a read-only code. In this instance, accordingly, the source file resides on a disk medium. A pointer returned by a specific function called mmap( ) may be used to initialize a current position character pointer. Various functions within the parser advance the current position character pointer whenever the function consumes the tokens represented by those characters. It should be recognized that by using the memory mapping technique, any function can replace “consumed” characters by simply adjusting the current position backward to a previous point in the source—typically to where the token or the syntactic element began.

One of ordinary skill in the art should appreciate that the parser functionality can be enhanced by allowing it to accept the input source file as a stream instead of requiring a disk file. In this approach, one exemplary implementation would be to have the parser recognize that the input file is a stream, copy it to a temporary disk file, operate normally, and then delete the temporary disk file.

Often in parsing a C program there are several possible syntactic elements that are legal at the current position in the source code being parsed. In order to determine which syntactic element is actually present at that position, the parser implements what are known as Is functions. These functions are named beginning with the word “Is” and followed by the name of the syntactic element that the function considers. If the Is function determines that the current syntactic element matches the name, then the Is function returns TRUE, otherwise it returns FALSE. For example, the Is function “IsStatement( )” returns TRUE when the syntactic element at the current position of the source code being parsed is a statement and FALSE when it is not.

When an Is function returns to its caller, the current position within the source code must be the same as when the Is function was called. Most Is functions implement this requirement by saving the current position upon entry and restoring it just before returning. An Is function is allowed to modify the current position temporarily during its execution. Usually this happens because the Is function needs to consume tokens or some other syntactic element in order to determine whether or not the current syntactic element is its type.

Typically, in the presently preferred exemplary embodiment of the present invention, the parser itself produces little output, except diagnostic printouts. Output is normally generated by the code that may be added to the parser in order to accomplish some additional purpose. The diagnostic printouts may be provided as a hierarchical, outline format print of the entry to and exit from each function within the parser, along with a few characters from the current position to help identify what part of the input source the parser is handling. The parser implements this functionality internally by calling a first function named ParseEnter( ) as the first executable statement within each function and by calling a second function named ParseLeave() as the last executable statement before the return. Preferably, parser functions are implemented such that there is a single entry and single return point, as exemplified below:

FunctionName()
{

int irc = 0; / / Integer Return Code
ParseEnter(“FunctionName) ;
/* Logic of the function goes here */

EXIT: ;

ParseLeave(“FunctionName) ;
Return irc; / / irc is the Integer Return Code

}

Whereas the trace printout generated by such code can become quite large and the parser functionality may slow down, the resulting output can be very helpful as a diagnostic tool for the parser.

As alluded to hereinabove, the recursive-descent C parser described herein is provided with one or more predetermined code modification portions that are operable to insert appropriate instrumentation code into the source code being parsed. Preferably, the parser may be run between the C pre-processor and compiler so that it runs on input files that are free from comments, macros, and the like. Accordingly, in some implementations, it may be necessary to effectuate the step of pre-processing the source code prior to executing the parser code (step 104).

The modification code portion in the parser is preferably operable to scan the expressions in the source code for inserting the instrumentation code at the start of each expression having global variables (step 106). Based on the modification code of the parser, instrumentation code is inserted into the source code at predetermined locations (step 108), thereby generating what may be referred to as instrumented source code. In one exemplary embodiment, such instrumentation code comprises counters placed in the front of the expressions, wherein when the compiled expression is executed, the counter will be incremented for each GV mentioned in the expression. Preferably, the instrumentation code is operable in such a manner as to not alter the functionality of the original expression. An exemplary counter instrumented expression can be as follows: if (nmpinfo_GV++,nmpinfo> . . . ), where the nmpinfo_GV++ counter is operable to keep track of accesses to the GV nmpinfo in the expression. In another exemplary instrumentation code implementation, counters may be inserted to measure function call frequency, rather than measuring GV access frequency. Additional variations of the instrumentation code include, for example, code for tracking the frequency of use of multiple code paths in the source code, for measuring GV accesses from a particular module of the source code, et cetera. If a module-specific instrumentation is used, an exemplary instrumentation counter can be as follows: if (boot_machdep_nmpinfo_GV++,nmpinfo> . . . ), where the nmpinfo GV++ counter is operable with respect accesses from the module boot_machdep.

The instrumented source code generated as the output of the parser operations can be compiled and linked into an executable version of the computer program (step 110). Thereafter, suitable test loads can be run with the executable version of the instrumented source program on an appropriate hardware platform (or, on an architectural simulator if the hardware for running the source program is not available) for exercising the different parts of the source code (step 112).

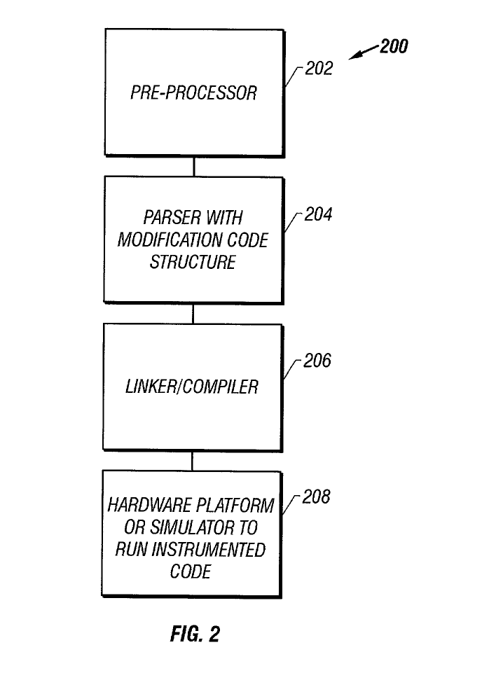

Referring now to FIG. 2, depicted therein is an exemplary high level functional block diagram of a source code modification system 200 provided in accordance with the teachings of the present invention. A pre-processor block 202 is provided for pre-processing the source code so as to remove any macros, comments, and the like as explained hereinabove. Means such as a parser 204 is operably coupled to the pre-processor block 202 for scanning the source code to recognize select syntax structures therein. The parser structure 204 includes a modification code structure for instrumenting the source code selectively and automatically. A linker/compiler block 206 is provided as part of the source code modification system 200 for compiling and linking the instrumented source code into an executable version. As alluded to hereinabove, a suitable hardware platform or simulator 208 is provided for running the executable version of the instrumented source code using different test loads.

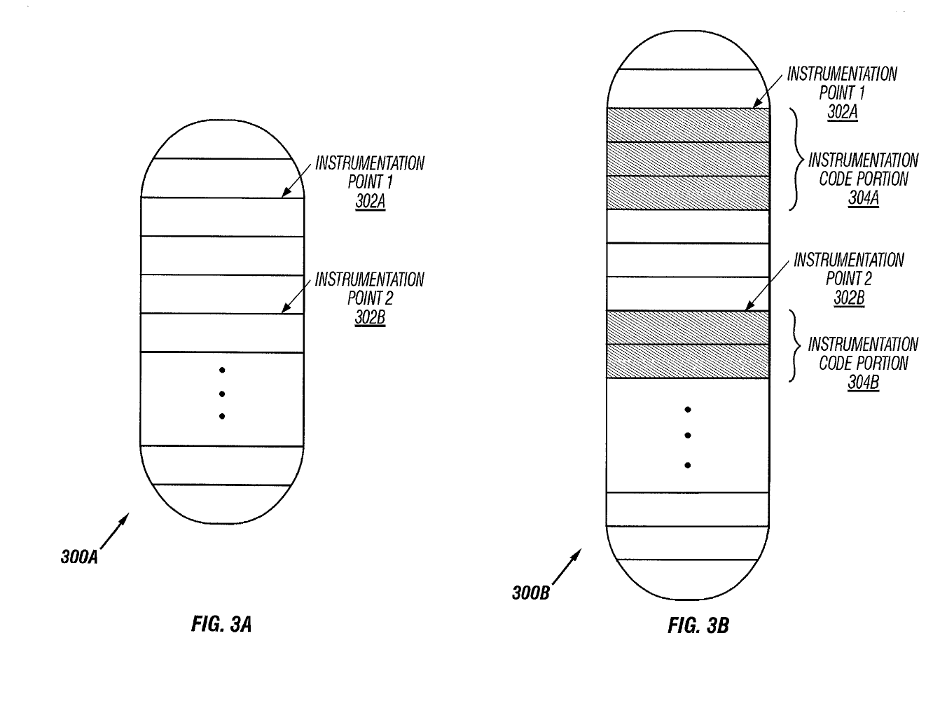

FIG. 3A depicts an exemplary embodiment of a source code portion 300A prior to instrumentation modification. Two instrumentation points 302A and 302B are illustrated herein. The parser block operable with the source code portion 300A in accordance with the teachings of the present invention includes a code modification portion associated with each of these two instrumentation points. FIG. 3B depicts the exemplary source code portion 300B after instrumentation modification. Two instrumentation code portions 304A and 304B are inserted at instrumentation points 302A and 302B, respectively, based on the code modification portions of the parser employed.

It should be appreciated that the source code modification scheme described hereinabove provides an instrumentation software tool that can be customized during the insertion process to include information specific to the point of insertion. In the presently preferred exemplary implementation, the instrumentation tool of the present invention comprises a system for monitoring GV access frequency in the HP-UX Operating System kernel under different test loads. GV counter data for the different test loads can therefore be obtained advantageously for purposes of analyzing the kernel performance and for providing appropriate diagnostic statistics. In an exemplary embodiment, the GV instrumentation tool optimized for the HP-UX kernel is comprised of the following files: (i) a PERL script gvcc64 file which changes the build environment by replacing the build environment wrapper for the C compiler; (ii) a PERL script gvcount file for automating the procedure by taking the source file list and performing a clearmake process; (iii) a C language gvparse file optimized for inserting GV counter instrumentation; (iv) a PERL script gvsort file for sorting the GV counter data collected by GV name; and (v) a generic C language parse file for instrumenting based on specific implementation. Preferably, the gvsort file for sorting the GV counter data operates by taking the raw data and producing both module-specific and non-module-specific counts.

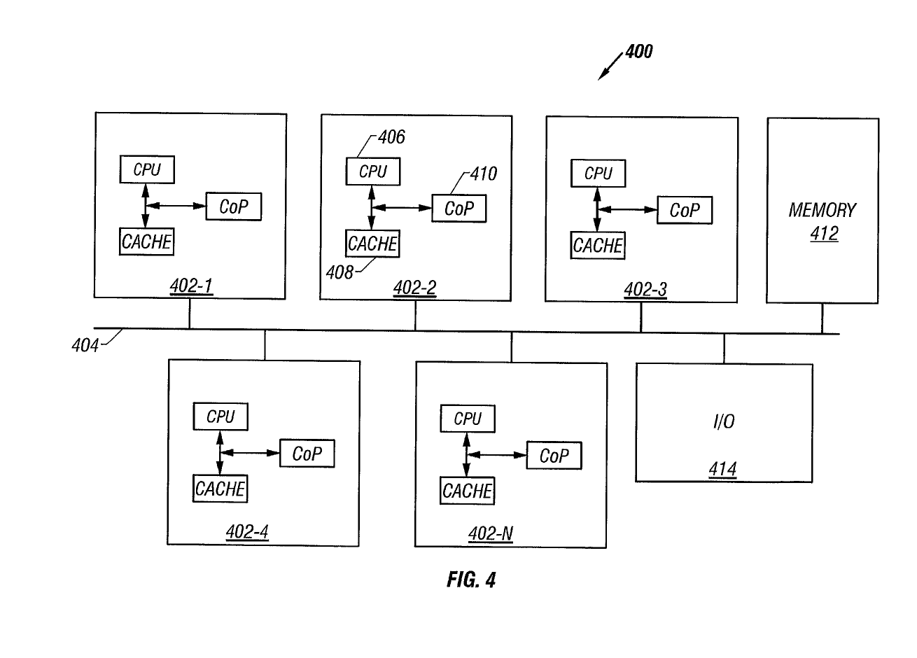

FIG. 4 depicts a block diagram of an exemplary multiprocessor (MP) hardware platform 400 operable to run the executable version of an instrumented computer program, e.g., the HP-UX Operating System kernel. Alternatively, the hardware platform 400 is a target processor environment simulated in an architectural simulator wherein the instrumented computer program can be executed in accordance with the teachings of the present invention. Reference numerals 402-1 through 402-N refer to a plurality of processor complexes interconnected together via a high performance, MP-capable bus 404. Each processor complex, e.g., processor complex 402-2, is comprised of a central processing unit (CPU) 406, a cache memory 408, and one or more coprocessors 410. Preferably, the MP system is architectured as a tightly coupled SMP system where all processors have uniform access to a main memory 412 and any input/output (I/O) device 414 in a shared fashion. As an SMP platform, each processor has equal capability to enable any kernel task to execute on any processor in the system. Whereas threads may be scheduled in parallel fashion to run on more than one processor complex, a single kernel controls all hardware and software in an exemplary implementation of the MP system 400, wherein locking and synchronization strategies provide the kernel the means of controlling MP events.

Continuing to refer to FIG. 4, each processor complex is preferably provided with its own data structures, including run queues, counters, time-of-day information, notion of current process(es) and priority. Global data structures available for the entire MP system 400 are protected by means such as semaphores and spinlocks. Furthermore, in other implementations of the MP system, the processors may be arranged as “cells” wherein each cell is comprised of a select number of processors (e.g., 4 processors), interrupts, registers and other resources.

Based upon the foregoing Detailed Description, it should be readily apparent that the present invention provides an efficient scheme for selectively and automatically modifying the source code of a computer program without the shortcomings and drawbacks of the state-of-the-art solutions as set forth in the Background section of the present patent application. The recursive-descent C parser provided in accordance herewith is operable to scan the entire source of the input software and to insert code at all points where instrumentation data needs to be collected. Further, the source code modification scheme allows the source program being instrumented to run at very nearly full speed, thereby allowing the program to be exercised with heavy workloads and under realistic conditions.

Instrumentation data obtained in the practice of the present invention can be useful in analyzing the performance of any large, complex software program such as an operating system. Further, optimized interfaces can be redesigned at the kernel level of the operating system by collecting appropriate instrumentation data from well defined source code locations.

It is believed that the operation and construction of the present invention will be apparent from the foregoing Detailed Description. While the system and method shown and described have been characterized as being preferred, it should be readily understood that various changes and modifications could be made therein without departing from the scope of the present invention as set forth in the following claims.

What is claimed is:

1. A method of modifying a source code portion associated with a computer program, comprising the steps of:
scanning said source code portion using a parser to recognize at least one select syntax structure therein, said parser having a predetermined code modification portion; and
inserting an instrumentation code portion into said source code portion at a location associated with said select syntax structure based on said predetermined code modification portion of said parser.

2. The method of modifying a source code portion associated with a computer program as set forth in claim 1, wherein said parser comprises a recursive-descent C language parser, and further wherein said computer program is a C language program selected from the group consisting of an operating system kernel, an application program and a software utility program.

3. The method of modifying a source code portion associated with a computer program as set forth in claim 2, further comprising the step of pre-processing said source code portion.

4. The method of modifying a source code portion associated with a computer program as set forth in claim 3, wherein said pre-processing step is operable to remove macro code portions from said source code portion.

5. The method of modifying a source code portion associated with a computer program as set forth in claim 2, wherein said operating system kernel comprises HP-UX Operating System kernel.

6. The method of modifying a source code portion associated with a computer program as set forth in claim 2, wherein said instrumentation code portion is operable to count accesses to a particular global variable of said computer program.

7. The method of modifying a source code portion associated with a computer program as set forth in claim 2, wherein said instrumentation code portion is operable to count accesses to a particular function subroutine of said computer program.

8. The method of modifying a source code portion associated with a computer program as set forth in claim 2, wherein said instrumentation code portion is operable to count accesses to a particular global variable from a select module of said computer program.

9. The method of modifying a source code portion associated with a computer program as set forth in claim 2, wherein said instrumentation code portion is operable to monitor frequency of function calls from a plurality of select locations in said computer program.

10. The method of modifying a source code portion associated with a computer program as set forth in claim 2, wherein said instrumentation code portion is operable to monitor frequency of use of a plurality of code paths in said computer program.

11. The method of modifying a source code portion associated with a computer program as set forth in claim 2, wherein said operating system kernel is operable with a multiprocessor computer system.

12. A system for modifying a source code portion associated with a computer program, comprising:
parser means for scanning said source code portion to recognize at least one select syntax structure therein; and
means for automatically and selectively inserting an instrumentation code portion into said source code portion at a location associated with said select syntax structure based on a predetermined code modification portion provided with said parser means.

13. The system for modifying a source code portion associated with a computer program as set forth in claim 12, wherein said parser means comprises a recursive-descent C language parser, and further wherein said computer program is a C language program selected from the group consisting of an operating system kernel, an application program and a software utility program.

14. The system for modifying a source code portion associated with a computer program as set forth in claim 13, further comprising a pre-processor for removing macro code portions associated with said source code portion.

15. The system for modifying a source code portion associated with a computer program as set forth in claim 13, wherein said instrumentation code portion is operable to count accesses to a particular global variable of said computer program.

16. The system for modifying a source code portion associated with a computer program as set forth in claim 13, wherein said instrumentation code portion is operable to count accesses to a particular function subroutine of said computer program.

17. The system for modifying a source code portion associated with a computer program as set forth in claim 13, wherein said instrumentation code portion is operable to count accesses to a particular global variable from a select module of said computer program.

18. The system for modifying a source code portion associated with a computer program as set forth in claim 13, wherein said instrumentation code portion is operable to monitor frequency of function calls from a plurality of select locations in said computer program.

19. The system for modifying a source code portion associated with a computer program as set forth in claim 13, wherein said instrumentation code portion is operable to monitor frequency of use of a plurality of code paths in said computer program.

20. The system for modifying a source code portion associated with a computer program as set forth in claim 13, wherein said operating system kernel is operable with a multiprocessor computer system.

21. A computer-readable medium operable with a processing environment, said computer-readable medium carrying a sequence of instructions which, when executed in said processing environment, causes said processing environment to perform the steps of:
scanning a source code portion of a computer program using a parser to recognize at least one select syntax structure therein, said parser having a predetermined code modification portion; and
inserting an instrumentation code portion into said source code portion at a location associated with said select syntax structure based on said predetermined code modification portion of said parser.

22. The computer-readable medium operable with a processing environment as set forth in claim 21, wherein said parser comprises a recursive-descent C language parser, and further wherein said computer program is a C language program selected from the group consisting of an operating system kernel, an application program and a software utility program.

23. The computer-readable medium operable with a processing environment as set forth in claim 22, wherein said instrumentation code portion is operable to monitor frequency of use of a plurality of code paths in said computer program.

24. The computer-readable medium operable with a processing environment as set forth in claim 22, wherein said operating system kernel is operable with a multiprocessor computer system.

25. The computer-readable medium operable with a processing environment as set forth in claim 22, wherein said instrumentation code portion is operable to count accesses to a particular global variable of said computer program.

26. The computer-readable medium operable with a processing environment as set forth in claim 22, wherein said instrumentation code portion is operable to count accesses to a particular function subroutine of said computer program.

27. The computer-readable medium operable with a processing environment as set forth in claim 22, wherein said instrumentation code portion is operable to count accesses to a particular global variable from a select module of said computer program.

28. The computer-readable medium operable with a processing environment as set forth in claim 22, wherein said instrumentation code portion is operable to monitor frequency of function calls from a plurality of select locations in said computer program.
